(19) United States
(12) Patent Application Publication
(10) Pub. No.: US 2024/0286447 A1
(43) Pub. Date: Aug. 29, 2024

(54) TRAILER COMMUNICATION SYSTEM

(71) Applicant: Stoneridge Electronics AB, Solna (SE)

(72) Inventors: Troy Cooprider, White Lake, MI (US); Gabriel Lepage, Royal Oak, MI (US); John S. Germaine, Traverse City, MI (US); Dominik Marx, Novi, MI (US); Darren Schumacher, Ann Arbor, MI (US)

(21) Appl. No.: 18/657,104

(22) Filed: May 7, 2024

Related U.S. Application Data
(63) Continuation-in-part of application No. 18/282,349, filed on Sep. 15, 2023, now Pat. No. 11,993,113.
(60) Provisional application No. 63/613,397, filed on Dec. 21, 2023.
(60) Provisional application No. 63/213,938, filed on Jun. 23, 2021.

(51) Int. Cl. B60D 1/62; B60Q 1/30; B60R 1/25; B60R 1/26

(52) U.S. Cl. CPC B60D 1/62; B60Q 1/305; B60R 1/25; B60R 1/26

(57) ABSTRACT

A trailer communication system has a wiring harness configured to carry a plurality of control signals and a connector configured to communicate with a tractor. A sensor is configured to generate a sensor signal. A processor is interconnected between the sensor and the wiring harness, the processor configured to transform the sensor signal for transmission over the wiring harness with at least one of the plurality of control signals using common wires within the wiring harness. The processor is further configured to receive the plurality of control signals and to generate a command to a corresponding one of a plurality of trailer components based upon the plurality of control signals.

### CROSS-REFERENCE TO RELATED APPLICATIONS

This application claims priority to U.S. Provisional Application No. 63/613,397, filed Dec. 21, 2023 and is a continuation-in-part of U.S. Serial No. 18.282,349, filed Sep. 15, 2023, which is a 371 of International Application No. PCT/US22/34710 filed Jun. 23, 2022, which claims priority to U.S. Provisional Application No. 63/213,938 filed on Jun. 23, 2021.

### TECHNICAL FIELD

This disclosure relates to a system for providing communications between a tractor and a trailer, which may include a camera monitoring system (CMS) having a trailer-mounted camera.

### BACKGROUND

Mirror replacement systems, and camera systems for supplementing mirror views, are utilized in commercial vehicles to enhance the ability of a vehicle operator to see a surrounding environment. Camera monitoring systems (CMS) utilize one or more cameras to provide an enhanced field of view to a vehicle operator. In some examples, the mirror replacement systems cover a larger field of view than a conventional mirror or include views that are not fully obtainable via a conventional mirror. The area behind the trailer is a typical blind spot in a conventional mirror system.

### SUMMARY

In some aspects, the techniques described herein relate to a trailer communication system for a vehicle including a tractor and trailer. The system includes a sensor configured to generate a sensor signal. The system also includes a plurality of switches for connecting to a plurality of trailer components and a controller including at least one processor. The controller is configured to receive the sensor signal from the sensor and to receive a plurality of control signals for controlling a plurality of trailer components. The at least one processor is configured to transform the sensor signal for transmission over a wiring harness with at least one of the plurality of control signals using common wires within the wiring harness. The at least one processor is further configured to send a command to at least one of the plurality of switches based upon the plurality of control signals.

In some aspects, the techniques described herein relate to a trailer communication system further including the plurality of trailer components. Each of the plurality of trailer components is selectively connected to power by one of the plurality of switches.

In some aspects, the techniques described herein relate to a trailer communication system wherein the plurality of trailer components includes at least one light.

In some aspects, the techniques described herein relate to a trailer communication system further including a connector and a filter between the connector and the controller, wherein the connector is configured to connect to a wiring harness carrying the plurality of control signals.

In some aspects, the techniques described herein relate to a trailer communication system wherein the controller includes a chipset including the at least one processor and an encoder. The encoder is configured to embed the sensor signal into at least one of the plurality of control signals.

In some aspects, the techniques described herein relate to a trailer communication system wherein the sensor is at least one of a camera, a radar, a lidar, an infrared sensor and an ultrasonic sensor.

In some aspects, the techniques described herein relate to a trailer communication system wherein the sensor is a camera and the sensor signal is a video signal transmitted by the controller over the common wires at a speed of at least 15 Mb/s.

In some aspects, the techniques described herein relate to a trailer communication system wherein the controller is a second controller. The trailer communication system further includes a camera mirror system for a vehicle including: a camera system for mounting to a tractor and having fields of view of at least one of Class II and Class IV views; at least one display for mounting in a vehicle cab and configured to display the fields of view from the camera system; and a first controller in communication with the camera system and the at least one display.

In some aspects, the techniques described herein relate to a trailer communication system wherein the sensor is a camera configured to provide the sensor signal to the at least one display and wherein the sensor signal is a live video signal.

In some aspects, the techniques described herein relate to a trailer communication system including a camera configured to generate a video signal. At least one processor is configured to be connected to the sensor and to a connector providing a plurality of control signals for a plurality of trailer components. The at least one processor is configured to transform the video signal for transmission over a wiring harness connected to the connector with at least one of a plurality of control signals using common wires within the wiring harness. The at least one processor is further configured to receive the plurality of control signals and to generate a command to each of a plurality of trailer components based upon the plurality of control signals.

In some aspects, the techniques described herein relate to a trailer communication system further including a plurality of switch assemblies each configured to selectively provide power to one of the plurality of trailer components. Each of the plurality of switch assemblies is configured to receive one of the plurality of commands from the at least one processor.

In some aspects, the techniques described herein relate to a trailer communication system wherein each of the switch assemblies includes a current sensor for monitoring current to the associated trailer component and for indicating a condition of the associated trailer component to the at least one processor.

In some aspects, the techniques described herein relate to a trailer communication system installed in a trailer having the plurality of trailer components and the connector.

In some aspects, the techniques described herein relate to a trailer and trailer communication system further including the connector mounted on the trailer and wherein the wiring harness is connected to the connector and to a trailer.

In some aspects, the techniques described herein relate to a method for providing communication with a trailer. A first control signal is received at a trailer over a first wire of a plurality of wires in a wiring harness connected between the trailer and a tractor.A video signal is received from a camera mounted on a trailer. The video signal is transmitted over at least two of the plurality of wires in the wiring harness, including the first wire. A command is generated in response to the first control signal and is sent to a first switch controlling a first trailer component on the trailer.

In some aspects, the techniques described herein relate to a method further including receiving an indication of a status of the first trailer component. The indication of the status of the first trailer component is sent to the tractor.

In some aspects, the techniques described herein relate to a method including the switch selectively supplying power received over the wiring harness to the first trailer component based upon the command.

In some aspects, the techniques described herein relate to a method wherein the power received over the wiring harness is received on one of the plurality of wires in the wiring harness other than the first wire.

In some aspects, the techniques described herein relate to a method further including displaying video in tractor based upon the video signal.

In some aspects, the techniques described herein relate to a method wherein the first trailer component is a light.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitoring system (CMS) used to provide at least Class II and Class IV views.

FIG. 1B is a schematic top elevational view of a commercial truck with a camera mirror system providing Class II, Class IV, Class V and Class VI views.

FIG. 2A is a schematic of a trailer camera communications system.

FIG. 2B is a schematic of an alternate trailer communications system.

FIG. 3 is an end view of a trailer wiring harness connector.

FIG. 4 depicts an unshielded twisted wire pair used to connect a processor and a filter in a trailer wiring harness.

FIG. 5 is a schematic of an example implementation of the trailer camera communications system.

FIGS. 6A and 6B are examples of a sensor integrated into trailer light housings.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

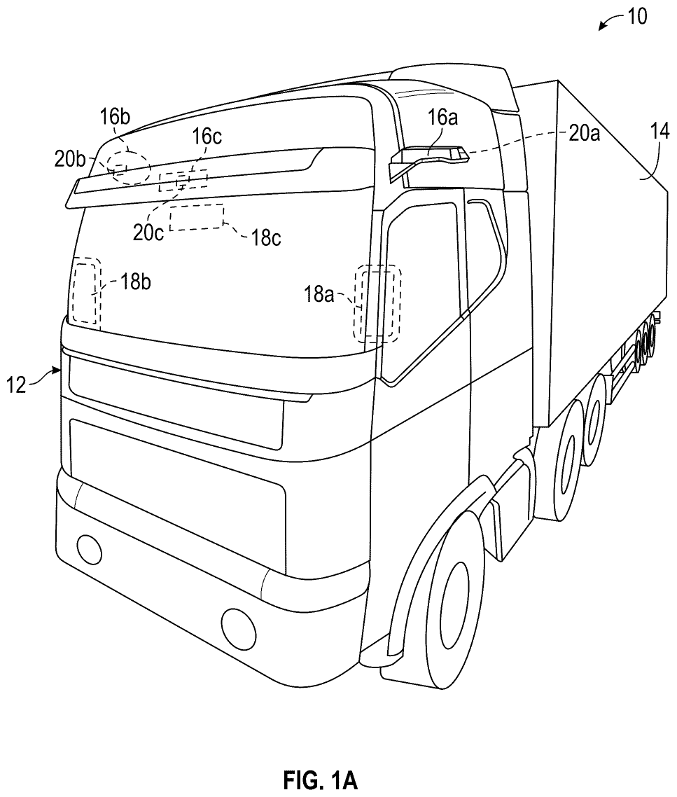

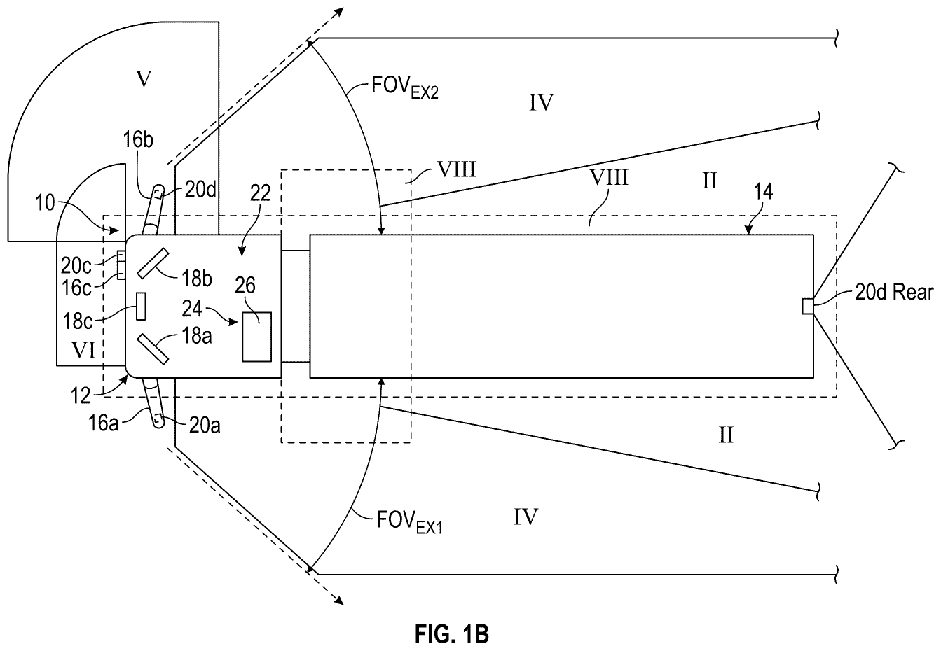

A schematic view of a commercial vehicle 10 is illustrated in FIGS. 1A and 1B. The vehicle 10 includes a vehicle cab or tractor 12 for pulling a trailer 14. Although a commercial truck is contemplated in this disclosure, the disclosed system may also be applied to other types of vehicles. The vehicle 10 incorporates a camera monitoring system or CMS 15 (FIG. 2A and FIG. 2B) that has driver and passenger side camera arms 16a, 16b mounted to the outside of the vehicle cab 12. If desired, the camera arms 16a, 16b may include conventional mirrors integrated with them as well, although the CMS 15 can be used to entirely replace mirrors. In additional examples, each side can include multiple camera arms 16, with each arm 16 housing one or more cameras and/or mirrors.

Each of the camera arms 16a, 16b includes a base that is secured to, for example, the cab 12. A pivoting arm is supported by the base and may articulate relative thereto. At least one rearward facing camera 20a, 20b is arranged respectively within the camera arms 16a, 16b, e.g., the pivoting arms. The exterior cameras 20a, 20b respectively provide an exterior field of view FOV_{EX1}, FOV_{EX2} that each include at least one of the Class II and Class IV views (FIG. 1B) or similar views, which are legal prescribed views in the commercial trucking industry. The Class II view on a given side of the vehicle 10 is a subset of the Class IV view of the same side of the vehicle 10. Multiple cameras also may be used in each camera arm 16a, 16b to provide these views, if desired. Each arm 16a, 16b may also provide a housing that encloses electronics that are configured to provide various features of the CMS 15.

First and second video displays 18a, 18b are arranged on each of the driver and passenger sides within the vehicle cab 12 on or near the A-pillars 19a, 19b to display Class II and Class IV views on its respective side of the vehicle 10, which provide rear facing side views along the vehicle 10 that are captured by the exterior cameras 20a, 20b.

If video of Class V and Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver.

If video of Class VIII views is desired, camera housings can be disposed at the sides and rear of the vehicle 10 to provide fields of view including some or all of the Class VIII zones of the vehicle 10. In such examples, the third display 18c can include one or more frames displaying the Class VIII views. Alternatively, additional displays can be added near the first, second and third displays 18a, 18b, 18c and provide a display dedicated to providing a Class VIII view.

It should be understood that more or fewer displays can be used than schematically illustrated, and the displayed images from more than one camera may be combined on a single display, or an image from a particular field of view may be provided on a separate, discrete display from another image.

The area behind the trailer 14 is a common blind spot for any vehicle, but particularly for commercial trucks. So, it is desirable to provide the operator some awareness of unseen objects at the rear of the trailer using a sensor, such as a camera 20d, as illustrated in FIG. 1B. Challenges to using a camera at the rear of a trailer 14 is the long run of wires that might be used to transmit a video signal to the display in the cab. Dedicated wiring would add significant cost to the system. Additionally, the video signal must be transmitted with minimal to no latency so objects are displayed in real time.

Each of the cameras 20a, 20b, 20c, 20d generates a live video signal. One or more of these video signals is transmitted to and displayed on the first video display 18a, the second video display 18b, and/or the third video display 18c.

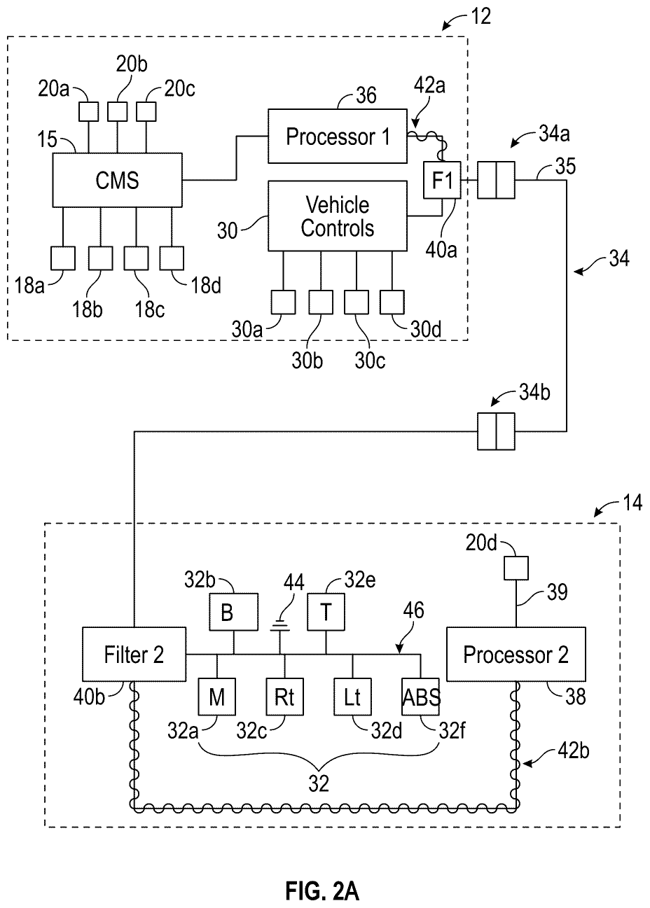

Referring to FIG. 2A, the trailer 14 includes trailer components 32, such as a marker light 32a, a brake light 32b, a turn signal (right, 32c; left, 32d), a tail light 32e, and an anti-lock braking system component 32f. Each of the trailer components 32a-32f (collectively, trailer components 32) are responsive to a control signal from one or more vehicle controls 30, e.g., switches 30a-30d. The trailer components 32 on the trailer 14 are connected to the tractor 12 by a typical wiring harness 34. As an example, a standard 7-pin jumper cable 35 interconnects the tractor 12 and trailer 14 at connectors 34a, 34b, which are of a typical configuration (e.g., FIG. 3). As a result, the disclosed system can be used with the existing ubiquitous trailer wiring harnesses and electrical connectors in the industry.

There are various ground wires 44 in the system, only some of which are shown. Wires within a common wiring harness 34 are unshielded copper wire, typically multiple copper wire strands covered in a polymer insulation. For a standard 7-pin arrangement, shown in FIG. 3, a common ground 44 is provided, and control signals for the marker light 32a, the brake light 32b the turn signal (right, 32c; left, 32d), the tail light 32e, and auxiliary power 32f (which may be used, for example, for the anti-lock braking system component), are respectively sent over power wires 46a-46f. The invention is not limited to any particular pin arrangement. For example, the pin arrangement of SAE J560 and ISO1185 could be used.

The camera 20d has an image capture unit that generates a sensor signal that must be sent at a high transmission rate. The disclosed system accomplishes this transmission without the need for dedicated wiring running from the rear of the trailer 14 all the way to the tractor 12, which greatly simplifies installation and reduces cost. Desired sensor signal transmission is achieved over the very same power wires on the trailer 14 used to transmit control signals to the trailer components 32.

The tractor 12 has a first controller 36 that transmits the received sensor signal to the CMS 15 for display to the operator. A second controller 38 is arranged on the trailer 14 and interconnected between the camera 20d (or sensor) and the wiring harness 34. Each of the first controller 36 and the second controller 38 includes at least one processor and associated electronic storage storing instructions, which when executed by the associated controller perform the functions as described herein. Additionally, each of the first controller 36 and second controller 38 include a plurality of inputs and outputs having any necessary additional hardware for receiving and sending the signals, information and commands as described herein.

The second controller 38 is configured to transform the sensor signal for transmission over the wiring harness 34 with the control signal using wires that are common with the wiring harness wires used to carry control signals to the trailer components 32. Said another way, several of the existing wires, e.g., a power wire and a ground wire, have a dual purpose: carrying a control signal and the sensor signal. An example chipset that may be used is available as VA6000 from Valens Semiconductor Ltd., although it should be understood that other processors can be used and fall within the scope of the disclosed system. Another example chipset is the DCB1M available from Yamar Electronics Ltd. The example chipsets each include at least one processor for transforming the signal for transmission over the wiring harness, along with suitable electronic storage storing instructions, which when executed by the at least one processor cause the chipset to perform the transformation of the sensor signal.

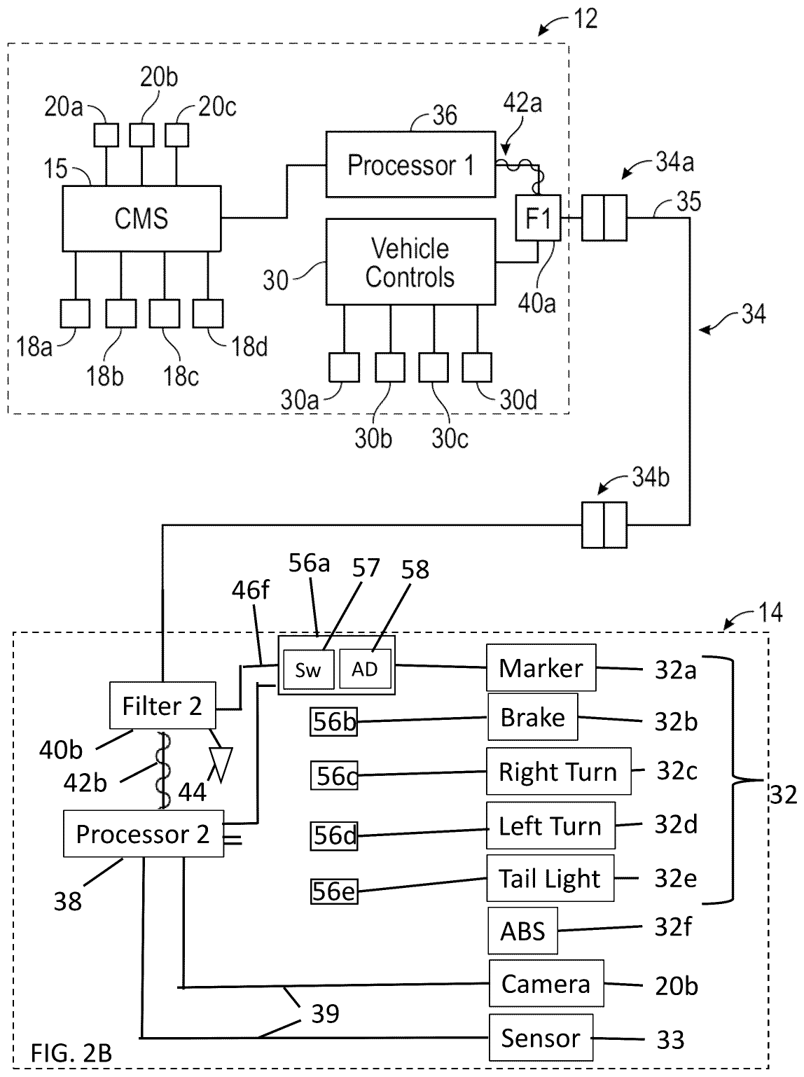

Noise is generated by the trailer components 32, such that a usable image signal may not be provided to the first and second controllers 36, 38. So, first and second filters 40a, 40b are used at the signal tap locations, for example, respectively in the tractor and trailer wiring harness to filter out noise prior to transmission to the processors. Each of the filters 40a, 40b are connected to its respective first and second controller 36, 38 by an unshielded twisted pair of wires 42a, 42b (shown as “42” in FIG. 4). The twisted wire pairs are unshielded copper wire, typically multiple copper wire strands 48 covered in a polymer insulation 50, as shown in FIG. 4. Alternatively, the wires 42a, 42b could be shielded.

The second controller 38 includes an input, and the camera 20d is connected to the input by a high-speed transmission cable 39, such as an ethernet cable. The second controller 38 may be provided by a chipset that includes a processor and an encoder, which is configured to embed the sensor signal into the control signal for transmission along the power wire(s) to the first controller 36. Additional electrical devices may be connected to multiple inputs, if provided on the processor. The other inputs may accommodate, for example, IRLEDs associated with the camera 20d. The chipset may include a multiplexer configured to combine the inputs to provide the sensor signal as an output of the sensor along with outputs from the electrical devices.

The first controller 36 includes a decoder and a demultiplexer, which can be provided on the same chipset or separately, that are configured to isolate the sensor signal from the control signal. The decoder is provided by at least one of hardware and software.

At least one of the first and second controllers 36, 38 may be configured to perform pulse amplitude modulation to reduce noise in the control signal over the common power wires.

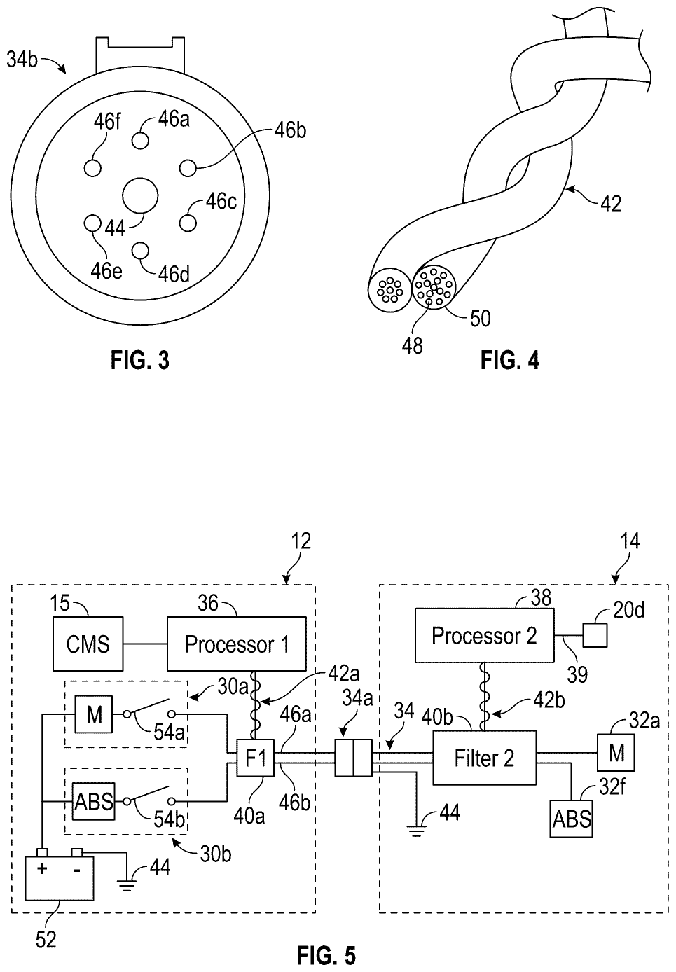

In operation, with reference to FIG. 5, the second controller 38 is configured to receive the sensor signal from the camera 20d and transmit the sensor signal to CMS 15. The second controller 38 embeds the sensor signal with the control signal on the power wires for the trailer components 32, such as over ABS and marker light power wires 46a, 48b. This combined sensor/control signal is transmitted along the trailer wiring harness 34 to the second filter 40b to filter any noise from the trailer components. Ideally, the second filter 40b is placed at a location and on power lines where the noise can be more easily filtered and to reduce the length of wires between the second filter 40 and the second controller 38.

The combined sensor/control signal is transmitted to the tractor 12 to a point “downstream” from vehicle component switches 54a, 54b to the first controller 36, where the sensor signal is decoded and transmitted to the CMS controller 15 for display. Each or both of the sensor signal and/or control signal may also be transmitted bi-directionally, if desired. The vehicle component switches 54a, 54b (e.g., trailer marker light switch and brake pedal) are connected to a power source 52, such as the vehicle's battery to selectively supply voltage, i.e., the control signal, to the trailer component. The first filter 40a must be located on the same pair of power transmission lines as the second filter 40b. The first filter 40 filters noise from the power wires to isolate the image signal sent from the second controller 38.

Although the sensor is described above as a camera 20d, it should be understood that other sensors may also be used in addition to or instead of a camera, such as a radar sensor, a lidar sensor, an infrared sensor and an ultrasonic sensor. In the case of a camera, it is desirable to transmit the sensor signal between the first and second controllers 36, 38 and on to the CMS 15 over the common wires at a speed of at least 15 Mb/s. Compressing the sensor signal could result in undesired latency. The disclosed system is capable of achieving the desired transmission rate, without compression, with the minimal latency needed in a CMS system, i.e., less than 200 ms.

FIG. 2B provides an alternative trailer communication system. In this example, the tractor 12 and the hardware components therein are the same as they were in FIG. 2A, although they are not required to be.

The trailer 14 again includes the second filter 40b and the second controller 38. As will be described below, the second controller 38 may include additional hardware and is programmed differently from how it was programmed in the FIG. 2A example.

The trailer 14 includes trailer components 32 similar to those in FIG. 2A, such as a marker light 32a, brake light 32b, turn signals (right turn 32c; left turn 32d), and a tail light 32e. Each of the trailer components 32a-32e (collectively, trailer components 32) is responsive to a control signal from one or more vehicle controls 30, e.g., switches 30a-30d. An anti-lock braking system component 32f or other accessory may also be installed on the trailer 14. The camera 20d and/or a sensor 33 may also be installed on trailer 14.

The tractor 12 is connected to the trailer 14 by a typical wiring harness 34. As an example, a standard 7-pin jumper cable 35 interconnects the tractor 12 and trailer 14 at connectors 34a, 34b, which may be of a typical configuration (e.g., FIG. 3), in which case, the disclosed system could be used with the existing ubiquitous trailer wiring harnesses and electrical connectors in the industry.

There are various ground wires 44 in the system, only some of which are shown. Wires within a common wiring harness 34 are unshielded copper wire, typically multiple copper wire strands covered in a polymer insulation. For a standard 7-pin arrangement, shown in FIG. 3, a common ground 44 is provided, and control signals for the marker light 32a, brake light 32b, turn signals (right, 32c; left, 32d), and tail light 32e are sent over power wires 46a-46e, respectively. Auxiliary power (i.e. always on) is provided over wire 46f.

Again, the camera 20d has an image capture unit that generates a sensor signal that must be sent at a high transmission rate. The camera 20d may be a visible light digital camera generating a live video signal. Sensor 33 may be a digital video camera other than a visible light camera, generating a sensor signal, such as a live video signal. Sensor 33 may be a radar sensor, a lidar sensor, an infrared sensor, an ultrasonic sensor or other sensor other than a visible light sensor. The sensor signal from sensor 33 must also be sent at a high transmission rate. Each sensor signal transmission is achieved over a different subset of the very same wires 46 on the trailer 14 normally used to transmit control signals and/or power from the vehicle controls 30 to the trailer components 32. The first controller 36 in the tractor 12 receives the sensor signal(s) (from camera 20d and/or sensor 33) over the wire harness 34 and transmits the received sensor signal(s) to the CMS 15 for display to the operator.

The second controller 38 includes at least one input, such as a network connection, to which the camera 20d and sensor 33 are connected by a high-speed transmission cable 39, such as an ethernet cable. The second controller 38 may have a pair of inputs, one for each of the camera 20d and the sensor 33 through which the second controller 38 receives the sensor signals.

The second controller 38 may include at least one chipset that includes a processor and an encoder, which is configured to embed the sensor signal(s) into the control signal for transmission along the power wire(s) to the first controller 36. Additional electrical devices may be connected to multiple inputs, if provided on the processor. The other inputs may accommodate, for example, IRLEDs associated with the camera 20d. Each chipset may include a multiplexer configured to combine the inputs to provide the sensor signals as an output of the sensor along with outputs from the electrical devices.

The first controller 36 includes a decoder and a demultiplexer, which can be provided on the same chipset or separately, that are configured to isolate the sensor signal from the control signal. The decoder is provided by at least one of hardware and software.

At least one of the first and second controllers 36, 38 may be configured to perform pulse amplitude modulation to reduce noise in the control signal over the common power wires.

A plurality of switch assemblies 56a-e selectively provide power from the auxiliary power wire 46f (optionally after passing through the second filter 40b) to each of the trailer components 32a-e, respectively.

Each of the plurality of switch assemblies 56a-e includes a switch 57 selectively providing power from the auxiliary power wire 46f to the associated one of the trailer components 32a-e (only the connections to one of the switch assemblies 56a-e is illustrated for clarity).

Each switch assembly 56a-e further includes an analog-to-digital converter and/or current sensor 58 measuring the current being provided to the associated trailer component 32a-e. The auxiliary power 46f may also be provided from the second filter 40b to the camera 20b and sensor 33.

In this embodiment, the second controller 38 receives the control signals in the wiring harness 34 intended for each of the trailer components 32 (or a subset thereof), the camera 20d, and the sensor 33. As shown, the second controller 38 may receive these signals from the filter 40b (which may filter each wire independently). Appropriate hardware in the second controller 38 converts the control signals in the wiring harness 34 to a suitable signal for the at least one processor in the second controller 38.

Each of the plurality of switch assemblies 56a-e is in communication with the second controller 38 (again only one connection between the second controller 38 and the switch assemblies 56a-e is illustrated). The second controller 38 is programmed to send commands to control each switch 57 to open or close based upon the control signals received on wires 46a-e from vehicle controls 30. Each sensor 58 monitors current being provided to the respective trailer component 32 and reports the status or any anomalies (e.g. light out) back to the second controller 38, which in turn may report such conditions back to the first controller 36 to alert the driver (e.g. via the CMS or other display/alerts).

For example, if the second controller 38 receives an “on” command on the marker light wire 46a, then the second controller 38 sends a command to switch 57 within switch assembly 56a to switch on and provide power from wire 46f to the marker 32a. As it does, the sensor 58 monitors the current level provided from switch assembly 56a to the marker 32a. If the marker 32a light is out or damaged, the sensor 58 will detect the low current or lack of current and send an alert signal to the second controller 38. The other switch assemblies 56b-e would work similarly with their respective trailer components 32b-e.

The switch assemblies 56a-e are preferably mounted in the trailer closer to the second controller 38 than to the respective trailer components 32 to which they are connected. In another example, the switch assemblies 56a-e may be mounted in the trailer proximate the second controller 38 (e.g. in a common housing or on a common mounting surface), in which case minimal modification or redesign of any existing trailer 14 would be required.

Alternatively, the switch assemblies 56a-e may be mounted in the trailer closer to the respective trailer components 32 to which they are connected than to the second controller 38. In another example, each switch assembly 56a-e can be mounted proximate its respective trailer component 32 (e.g. a common housing or common mounting surface).

Alternatively, some combination of mounting locations can be used. For example, at least one of the switch assemblies 56-e can be proximate the second controller 38 and at least one of the switch assemblies 56a-e can be proximate its respective trailer component(s) 32.

As before, the second controller 38 is also configured to transform the sensor signal(s) (from camera 20d and/or sensor 33) for transmission over the wiring harness 34 with the control signal using wires that are common with the wiring harness wires intended to carry control signals to the trailer components 32. Again, an example chipset that may be used is available as VA6000 from Valens Semiconductor Ltd., although it should be understood that other processors can be used and fall within the scope of the disclosed system. Another example chipset is the DCB1M available from Yamar Electronics Ltd.

Noise may be generated by the vehicle controls 30 and/or the trailer components 32, such that a usable image signal may not be provided to the first controller 36 and the second controller 38. Therefore, the first filter 40a and the second filter 40b are used at the signal tap locations, for example, respectively in the tractor and trailer wiring harness 34 to filter out noise prior to transmission to the processors. Each of the filters 40a, 40b may be connected to its respective first and second controller 36, 38 by an unshielded twisted pair of wires 42a, 42b (shown as “42” in FIG. 4). The twisted wire pairs are unshielded copper wire, typically multiple copper wire strands 48 covered in a polymer insulation 50, as shown in FIG. 4. Alternatively, the wires 42a, 42b could be shielded.

In operation, with reference to FIG. 2B, the second controller 38 receives the sensor signal(s) from the camera 20d and/or sensor 33 and transmits the sensor signal(s) to CMS controller 15. The second controller 38 embeds the sensor signal(s) with the control signal on the power wires for the trailer components 32, such as over auxiliary power 46f and marker light wire 46a. The sensor signals from the camera 20d and sensor 33 (if both are present) may be transmitted over different pairs of the plurality of wires 46. This combined sensor/control signal is transmitted along the trailer wiring harness 34 to the second filter 40b to filter any noise from the trailer components. Ideally, the second filter 40b is placed at a location and on power lines where the noise can be more easily filtered and to reduce the length of wires between the second filter 40 and the second controller 38.

The filters 40a, 40b control the impedance of the data transmission lines while rejecting external high frequency noise introduced by components on either the tractor or trailer (prior to reaching the filters 40a, 40b). The filters 40a, 40b protect the transmission lines from external interference. The filters 40a, 40b also mitigate the effects of insertion loss when the signal is superimposed over the power line.

The filters 40a, 40b may be inductors which create a low pass filter allowing the normal operation of the trailer circuit (for example the turn signal on/off) while the controllers 36, 38 inject high frequency ‘noise’ over those existing lines. The inductors in the filter 40a reject the high frequency noise from either the tractor connected circuits (upstream from the tractor filter 40a) or trailer connected circuits (downstream from the trailer filter 40b).

A design goal with the filters 40a, 40b is to make the transmission line between the tractor and trailer filters 40a, 40b as short as possible because that is where the majority of the noise is introduced due to unshielded, non-twisted pair wiring.

The capability to filter noise out relies primarily on utilizing PAM at the signal level and utilizing twisted pair wiring as much as possible when transmitting a signal as twisted pairs are more robust to noise due to the differential signal convention and the way noise affects those twisted pairs.

The combined sensor/control signal is transmitted to the tractor 12 to a point “downstream” from vehicle component switches 54a, 54b to the first controller 36, where the sensor signal is decoded and transmitted to the CMS controller 15 for display. Each or both of the sensor signal and/or control signal may also be transmitted bi-directionally, if desired. The vehicle component switches 54a, 54b (e.g., trailer marker light switch and brake pedal) are connected to a power source 52, such as the vehicle's battery to selectively supply voltage, i.e., the control signal, to the trailer component. For each of the camera 20b and sensor 33, the first filter 40a must be located on the same pair of power transmission lines as the second filter 40b. The first filter 40 filters noise from the wires to isolate the image signal sent from the second controller 38.

In the case of the camera 20b and sensor 33, which are generating live video signals, it is desirable to transmit the sensor signal between the first and second controllers 36, 38 and on to the CMS 15 over the common wires at a speed of at least 15 Mb/s. Compressing the sensor signal could result in undesired latency. The disclosed system is capable of achieving the desired transmission rate, without compression, with the minimal latency needed in a CMS system, i.e., less than 200 ms.

In FIGS. 2A and 2B, each of the first controller 36 and the second controller 38 includes at least one microprocessor and at least one non-transitory storage medium storing instructions which when executed by the at least one microprocessor cause the system to perform the functions described herein.

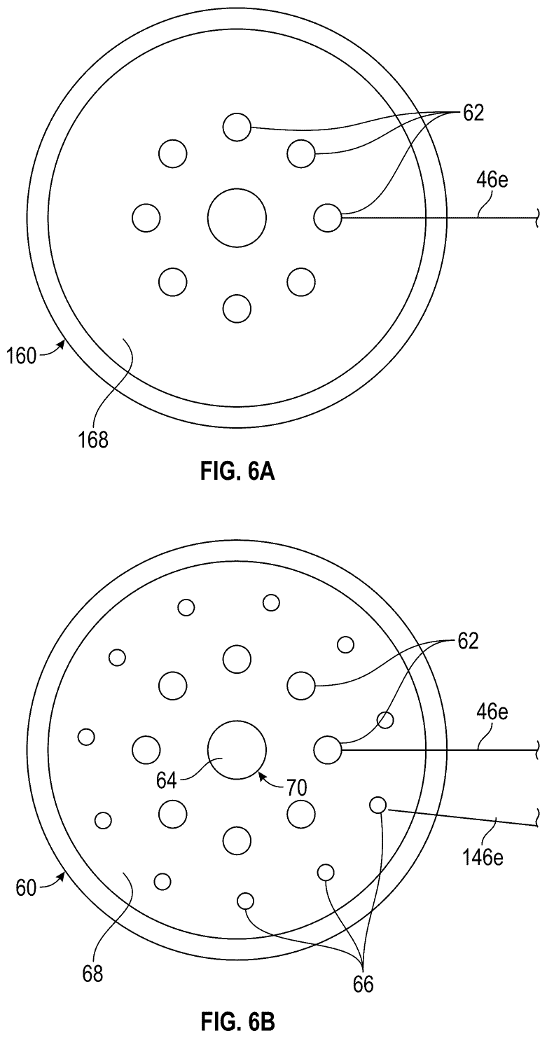

To provide further efficiencies, the sensor can be integrated into a light housing 60, 160 on the trailer 14, as shown in FIGS. 6A and 6B. Referring to FIG. 6B, a light housing 60 (e.g., a marker light, a tail light, a brake light and a turn signal) has the sensor 64, such as a camera 20d, provided in the housing 60. The lights 62 may be provided by LEDs or incandescent bulbs for emitting visible light. An array of IR LEDs 66 powered by wires 146e may also be provided in the housing 60 if night vision is desired for the camera. The light housing 60 is sealed by a lens 68, which may cover the sensor as well. If desired, a separate lens 70 may be used over the sensor 64 and integrated with the lens 68, depending upon the application. The light housing 160 in FIG. 6A uses a lens 168 and with no IR LEDs.

Incorporating IR LEDs, and optionally a camera, into a ubiquitous taillight assembly would obviate the need for any specialized mounting brackets or hardware when adding night vision or another view at the rear of the trailer.

The controller in the CMS can be used to implement the various functionality disclosed in this application. The controller may include one or more discrete units. The first controller 36 can be incorporated into the CMS controller or separate, but the second controller 38 will be separate from the first controller 36 as the second processor resides on the trailer 14. Moreover, a portion of the controller may be provided in the vehicle, while another portion of the controller may be located elsewhere. In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller may be a hardware device for executing software, particularly software stored in memory. The controller can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a display, macroclimate device, microclimate device, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed. It should be understood that the term “processor” in this application, including the claims, is used in the general sense and in application could be more than one microprocessor, CPU, CPU core or the like. Nothing in this application should be construed to limit the term “processor” to a singular structure.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content. Alphanumeric identifiers in method steps are only intended for ease of reference in dependent claims and do not signify a required sequence unless explicitly otherwise stated in the claims.

What is claimed is:

1. A trailer communication system for a vehicle including a tractor and trailer, the system comprising:
a sensor configured to generate a sensor signal;
a plurality of switches for connecting to a plurality of trailer components; and
a controller including at least one processor, the controller configured to receive the sensor signal from the sensor and to receive a plurality of control signals for controlling a plurality of trailer components, the at least one processor configured to transform the sensor signal for transmission over a wiring harness with at least one of the plurality of control signals using common wires within the wiring harness, the at least one processor further configured to send a command to at least one of the plurality of switches based upon the plurality of control signals.

2. The trailer communication system of claim 1 further including the plurality of trailer components, wherein each of the plurality of trailer components is selectively connected to power by one of the plurality of switches.

3. The trailer communication system of claim 2 wherein the plurality of trailer components includes at least one light.

4. The trailer communication system of claim 1 further including a connector and a filter between the connector and the controller, wherein the connector is configured to connect to a wiring harness carrying the plurality of control signals.

5. The trailer communication system of claim 1 wherein the controller includes a chipset including the at least one processor and an encoder, the encoder configured to embed the sensor signal into at least one of the plurality of control signals.

6. The trailer communication system of claim 1 wherein the sensor is at least one of a camera, a radar, a lidar, an infrared sensor and an ultrasonic sensor.

7. The trailer communication system of claim 1 wherein the sensor is a camera, and the sensor signal is a video signal transmitted by the controller over the common wires at a speed of at least 15 Mb/s.

8. The trailer communication system of claim 1 wherein the controller is a second controller, the trailer communication system further including a camera mirror system for a vehicle including:
a camera system for mounting to a tractor and having fields of view of at least one of Class II and Class IV views;
at least one display for mounting in a vehicle cab and configured to display the fields of view from the camera system; and
a first controller in communication with the camera system and the at least one display.

9. The trailer communication system of claim 8 wherein the sensor is a camera configured to provide the sensor signal to the at least one display and wherein the sensor signal is a live video signal.

10. A trailer communication system comprising:
a camera configured to generate a video signal; and
at least one processor configured to be connected to the camera and to a connector providing a plurality of control signals for a plurality of trailer components, the at least one processor configured to transform the video signal for transmission over a wiring harness connected to the connector with at least one of a plurality of control signals using common wires within the wiring harness, the at least one processor further configured to receive the plurality of control signals and to generate a command to each of a plurality of trailer components based upon the plurality of control signals.

11. The trailer communication system of claim 10 further including a plurality of switch assemblies each configured to selectively provide power to one of the plurality of trailer components, wherein each of the plurality of switch assemblies is configured to receive one of the plurality of commands from the at least one processor.

12. The trailer communication system of claim 11 wherein each of the plurality of switch assemblies includes a current sensor for monitoring current to the respective trailer component and for indicating a condition of the respective trailer component to the at least one processor.

13. The trailer communication system of claim 12 in combination with a trailer having the plurality of trailer components and the connector, wherein the trailer communication system is installed in the trailer.

14. The trailer and trailer communication system of claim 13 further including the connector mounted on the trailer and wherein the wiring harness is connected to the connector and to a trailer.

15. A method for providing communication with a trailer including:
a) receiving on a trailer a first control signal over a first wire of a plurality of wires in a wiring harness connected between the trailer and a tractor;
b) receiving a video signal from a camera mounted on a trailer;
c) transmitting the video signal over at least two of the plurality of wires in the wiring harness, wherein the at least two of the plurality of wires include the first wire;
d) generating a command in response to the first control signal; and
e) sending the command to a first switch controlling a first trailer component on the trailer.

16. The method of claim 15 further including:
f) receiving an indication of a status of the first trailer component; and
g) sending the indication of the status of the first trailer component to the tractor.

17. The method of claim 16 wherein step e) includes: the first switch selectively supplying power received over the wiring harness to the first trailer component based upon the command.

18. The method of claim 17 wherein the power received over the wiring harness is received on one of the plurality of wires in the wiring harness other than the first wire.

19. The method of claim 18 further including displaying video in a tractor based upon the video signal.

20. The method of claim 18 wherein the first trailer component is a light.
